(19) United States
(12) Patent Application Publication
(10) Pub. No.: US 2025/0264179 A1
(43) Pub. Date: Aug. 21, 2025

(54) DEVICE FOR DISTRIBUTION OF A MATERIAL

(71) Applicant: Frewitt fabrique de machines SA, Granges-Paccot (CH)

(72) Inventors: Antoine Virdis, Ferpicloz (CH); Yves Grossrieder, Russy (CH); Christian Rhême, Posieux (CH)

(21) Appl. No.: 19/058,262

(22) Filed: Feb. 20, 2025

(30) Foreign Application Priority Data
Feb. 20, 2024 (CH) 000173/2024

(51) Int. Cl. F16L 55/00

(52) U.S. Cl. CPC F16L 55/00

(57) ABSTRACT

The invention relates to a device (10) for the linear distribution of a material (M). This comprises a reservoir (20) mounted for movement about an axis defining a longitudinal direction, the reservoir delimiting a storage cavity (42) and being provided with a first opening (50) for the entry of material into said cavity and a second opening (60) in the form of a longitudinal slot for the exit of material from said cavity. The device also comprises means (30) for driving the reservoir (20) in an oscillating movement about its axis.

### FIELD OF THE INVENTION

The present invention relates to the processing of substances, in particular sticky or pulverized powders, for their linear distribution.

### STATE OF THE ART

Powders are used in a multitude of industrial processes, notably in the pharmaceutical, chemical or food industry.

These powders are typically obtained by processing in a mill a raw powder whose grains or agglomerates have an average diameter of, for example, between a few millimeters and several centimeters.

The mill delivers the powder thus obtained through an outlet or feed opening, generally circular in shape.

Sometimes, subsequent processing of the powder requires it to be distributed over a distance greater than the size of the mill outlet. This is the case, for example, when the powder is intended to form a continuous film of a specific width and is deposited as a layer of appropriate size on a downstream receiving device such as a conveyor belt.

So that the output film is homogeneous, the powder's volumetric and particle size distribution must be as optimal as possible.

There are currently distribution systems using rails and brushes to spread the material over a receiving surface. Other systems use substance distribution nozzles.

But rail and brush systems are cumbersome and difficult to adapt to different types of material, especially those with different flow properties. Nozzle systems, on the other hand, have the disadvantage of clogging easily when the powder is a sticky one.

Moreover, these different systems do not provide entirely satisfactory distribution in terms of volumetric and grain size homogeneity, resulting in frequent defects in the final product.

### SUMMARY OF INVENTION

One object of the present invention is to propose a linear distribution device of a material making it possible to resolve the aforementioned problems.

This object is attained thanks to the subject matter of the independent claims. More specific aspects of the present invention are described in the dependent claims as well as the description.

More specifically, an object of the invention is attained by means of a device for linear distribution of a material, the said device comprising:
a reservoir mounted so as to be movable about an axis defining a longitudinal direction, the reservoir delimiting a storage cavity and being provided with a first opening for the entry of material into the interior of the said cavity and with a second opening in the form of a longitudinal slot for the exit of material outside the said cavity; and
means of driving the reservoir in an oscillating movement about its axis.

The device according to the invention is intended for distributing a material over a rectilinear zone (segment or strip) of length L (hereinafter distribution zone), the length L corresponding to the length of the longitudinal slot of the reservoir.

More specifically, the device according to the invention is adapted to the treatment of a material fed through a feed orifice of length L0, for its distribution over a length L greater than L0, typically at least 2 times greater than L0, preferably from 2 to 10 times greater than L0.

The distribution device according to the invention is thus particularly designed to be installed downstream of a feed device delivering the material through a feed orifice of length L0 and upstream of a receiving device configured to receive the distributed material.

The material to be distributed is typically a powder, in particular a sticky or pulverized powder, more particularly a powder whose grains have an average diameter of between 50 microns and 1 millimeter.

The distribution device is advantageously configured for use in a continuous manufacturing process. The associated receiving device is in this case a mobile device, configured to move the material in a direction orthogonal to the dispensing zone, thus forming a continuous layer or film of material of width L.

In use, the axis of the distribution device, which defines the longitudinal direction, is therefore generally horizontal.

A radial direction is a direction orthogonal to the longitudinal direction.

When the device is in operation, an XYZ reference frame can be defined, with Y a horizontal radial direction and Z a vertical radial direction.

In operation, the material leaves the storage cavity through the second opening, by gravity and/or by forces linked to the oscillation movement causing the material to be ejected out of the cavity. The second opening is therefore oriented generally downwards, with respect to a horizontal plane XY passing through the axis of rotation X of the reservoir.

Generally, the material enters the storage cavity by gravity, although other arrangements are conceivable. Most of the time, however, the first opening will be oriented generally upwards, with respect to a horizontal plane XY passing through the axis of rotation X of the reservoir.

In the following, an equilibrium position of the reservoir is defined as its default position in the absence of oscillation. In this position, the second opening is typically vertically aligned with the axis of rotation of the reservoir, and preferably the second opening is orthogonally symmetrical with respect to a vertical plane XZ containing this axis of rotation.

During operation, the oscillations of the reservoir take place around the equilibrium position. The angle of oscillation of the reservoir is the maximum angle of rotation between the equilibrium position and its position furthest from this equilibrium position, during oscillation.

The second reservoir opening has a length corresponding to the length L over which the material is to be distributed at the outlet. Its width, on the other hand, is sufficiently small to ensure that the material is not discharged directly from the storage cavity, but is instead held there temporarily before distribution. It is easy to understand that the length and width of the second opening depend on the desired distribution width, and on the nature and in particular the particle size and flowability of the material, which may vary. The maintenance of a permanent reserve of material inside the reservoir and the oscillating movement of this reserve enable the material to be distributed with a homogeneous grain size inside the cavity and in particular over the entire length of the second opening. The material is thus distributed at the outlet with a homogeneous volume and grain size over the entire length L.

Oscillation parameters—in particular angle and frequency—are advantageously chosen according to the material's characteristics.

According to a particularly advantageous arrangement, the oscillation parameters are chosen so that oscillation of the reservoir causes relative oscillation between the material contained inside the storage cavity and the internal surface of said cavity. The volume of powder does not oscillate or oscillates less than the reservoir.

The drive means of the reservoir may comprise a motor, or a non-motorized drive system such as a connecting rod and crank.

The reservoir is typically integral with a shaft, rotatably mounted relative to a device frame. The drive means, for example, are mounted on this frame.

Inside the reservoir, the storage cavity advantageously has a cylindrical inner surface, preferably of circular or oval cross section, which limits material adhesion.

The reservoir, and in particular the inner surface of the storage cavity, may for example be made of a metallic material, notably stainless steel. The storage cavity may also be covered on the inside with a coating designed to limit material adhesion. The reservoir and/or a lining covering the inside of the storage cavity can also be made of a non-metallic material, typically a polymeric material such as PTFE, to prevent the material from being contaminated by wear particles.

Thanks to the temporary storage and oscillating distribution of the material inside the storage cavity, the device is particularly suitable for distributing along a given length L, material initially obtained through an outlet with a diameter smaller than said length L.

While the second opening is in the form of a slot, which is long and narrow by nature, the first opening can be any shape, including rectangular, square, circular or oval.

The length of the second opening, which determines the length of the material distribution zone, must be chosen or adjusted as required, but is typically between 500 and 2000 mm. Preferably, it is substantially equal to (i.e. strictly equal to or no more than 20 mm shorter than) the length of the storage cavity, so as to prevent the material from clogging at the ends of this cavity.

Generally, the length of the second opening is greater than the length of the first opening.

More specifically, the ratio between the length of the first opening (its maximum dimension measured in the longitudinal direction) and the length of the second opening can be between 0.1 and 0.5.

The length of the first opening can, for example, be between 50 and 500 mm.

As explained above, the width of the second opening must be small enough to prevent the immediate evacuation of the material introduced into the reservoir cavity. The width of the second opening is, for example, greater than 3 times the average particle diameter of the material, and preferably greater than 5 times this average diameter.

For example, the width of the second opening is between 1 and 15 mm.

The width of the first opening can, for example, be between 50 and 500 mm.

According to an advantageous arrangement, the first and second openings are opposite each other in a direction orthogonal to the longitudinal direction of the X axis (in other words, at least one radial direction intersects each of the two openings). Preferably, the first and second openings each exhibit symmetry with respect to the same radial plane.

In the present application, an opening or slot is a zone surrounding one or more juxtaposed orifices allowing the material to pass through.

Thus, each of the first and second openings may be formed by a single, completely through-going orifice, or may be partially obturated by a lattice structure which nevertheless allows material to pass through.

According to a particular arrangement, the lattice structure may be a sieve, in particular a sieve formed of orifices of diameter between 1 and 15 mm, with said diameter corresponding to the diameter of a circle inscribed inside said orifice.

As the device is generally used in a continuous manufacturing process, it is advantageous for it to include means for adjusting the width of the second opening, in particular so as to be able to guarantee a constant output rate. For example, the width of the second opening can be adjusted as a function of sensors placed in the cavity to monitor the volume of material present, particularly at the ends of the cavity. By adjusting the width of the slot, it is possible to ensure that a reserve of material is permanently maintained inside the reservoir, whatever the properties of the material and/or the flow rate of material entering the reservoir.

According to one example, the second opening can be delimited at least partially by a movable element whose position is adjustable.

In particular, the reservoir may comprise a body including one or more movable elements delimiting the second opening.

It may also be mentioned that the sensors also make it possible, for example, to act on the flow of material entering the device.

Alternatively, or in addition, the reservoir can also include means for adjusting the length of the second opening, so as to adapt the length of the material distribution, particularly in relation to the length of a downstream receiving device. In this case, the length adjustment means can simultaneously adjust the length of the storage cavity, or can be coupled to ancillary means adjusting the length of the storage cavity.

To focus material distribution towards a downstream receiving device, the device can further comprise deflectors arranged outside the reservoir, and configured to guide the material out of the second opening.

The deflectors can be movable or they can be fixed. Preferably, the deflectors are arranged so that their outlet spacing is adjustable. Typically, this distance is between 5 and 100 mm. The deflectors are, for example, pivotally mounted in relation to the frame of the distribution device.

In another particular case of the invention, or additionally, the device comprises at least one flow-disrupting element inside the storage cavity.

The flow disruptors are intended to prevent the formation of agglomerates (pellets) of material, ensuring a constant grain size distribution along the entire length of the second opening.

A flow disrupter may, for example, be in the form of a bar, blade or helix, which is attached to the reservoir, preferably in line with the second opening. It may also be an element not attached to the reservoir, such as one or more balls.

Preferably, the flow disrupter extends over the entire length of the second opening, and even more preferably over the entire length of the storage cavity.

The device could also include at least one fluidizing element, for example integrated into the flow disrupter(s). Such a fluidizing element makes it possible to reinforce the effect of the oscillations, in particular by causing the material to migrate towards the ends of the cavity. Such elements may, for example, take the form of nozzles or a vibrating system.

In a particular embodiment of the invention, the distribution device further comprises at least one sensor configured to measure at least one parameter representative of the amount of material inside the storage cavity.

A parameter representative of the amount of material inside the cavity is, for example, the mass of material contained in the cavity, a height of material inside the cavity, a variation in the angle or speed of oscillation, etc.

The data supplied by the sensors can then be passed on to a control unit which compares the measured value with a target value or range of values and, if necessary, warns the user of any deviation from the target or makes one or more adjustments in order to return to the target (e.g. by adjusting the slot width, oscillation speed or frequency, material feed rate, etc.).

According to another aspect, the invention relates to a system for linear deposition of a material comprising:
a material feed device configured to deliver said material through an outlet;
a linear distribution device as previously defined; and
a receiving device arranged to receive the material distributed by the linear distribution device.

According to one example, the material feed device can be a mill.

Its outlet orifice is, for example, but not exclusively, a circular orifice.

The diameter of this outlet orifice (i.e. the maximum dimension of a circle inscribed in the orifice) is typically between 50 and 500 mm.

Thanks to the linear distribution device according to the invention, the ratio between the diameter of the outlet orifice (or feed orifice) of the feed device and the length of the second opening can be between 0.1 and 0.5.

According to one example, the system further comprises a deformable connecting element configured to connect the outlet orifice of the material feed device and the first opening in a sealed manner.

According to one example, the connecting element can be made of a flexible material. Flexible natural, synthetic or metallic materials can be used as flexible material.

The receiving device arranged to receive the distributed material is typically aligned with the feeding device in the vertical direction.

This may be a moving device, typically a conveyor belt or a roller mill.

According to another aspect, the invention relates to a method of using a linear distribution device as defined above for the distribution of a material, in which a quantity of material is introduced into the reservoir through the first opening and the reservoir is subjected to an oscillating movement about its axis to distribute the material through the second opening.

The quantity of material introduced, the width of the second opening and the oscillation characteristics of the reservoir are advantageously such that, during distribution, a reserve of material, and in particular a predefined quantity of material, is kept permanently inside the storage cavity.

Advantageously, the process includes a prior step of filling the reservoir so as to form the reserve of material before starting distribution.

The minimum height of the reserve, measured radially at one axial end of the second opening, is preferably greater than 25% of the diameter of the reservoir measured in the same radial direction.

The volume of the reserve is preferably at least 50% of the total internal volume of the storage cavity.

As previously described, the angle of oscillation of the reservoir about its axis is greater than 5 degrees, preferably between 5 and 45 degrees, more preferably between 10 and 30 degrees.

Similarly, the frequency of oscillation of the reservoir about its axis is at least 0.5 Hz, and may be between 1 and 20 Hz, preferably between 1 and 10 Hz.

According to one example, during distribution, the material is introduced continuously, and preferably at a constant flow rate, through the first opening.

For example, the material input rate through the first opening can be between 50 and 500 kg/h.

The output rate of material M through the second opening is generally substantially equal to this input rate.

By “substantially equal”, it is meant that the variation in flow rate preferably does not exceed a few %, typically 5%, which will be compensated for by the internal reserve. A small variation may be the result of variable material characteristics, such as temperature or humidity. In the event of greater flow variations, a measurement and control system as described above can be used.

According to one implementation example, at least one parameter representative of the amount of material inside the storage cavity can be measured during distribution.

In this case, at least one of the following parameters can be adjusted, if required: the flow rate of material entering through the first opening, the angle of oscillation of the reservoir, the frequency of oscillation of the reservoir and the width of the second opening, so that said parameter remains within a predetermined value range.

### BRIEF DESCRIPTION OF THE DRAWINGS

The features and the advantages of the present invention will emerge with more details in the context of the following description with an embodiment example given in an illustrative and non-limiting way, with reference to the attached drawings which represent:

FIG. 1 is a lateral view, in perspective, of a distribution device according to a first embodiment of the invention;

FIG. 2 is a view seen from above, in perspective, of the device of FIG. 1;

FIG. 3 is a view seen from below, in perspective, of a distribution device according to a second embodiment of the invention;

FIG. 4 is a cross-sectional view (i.e. along a plane orthogonal to the X axis) of the distribution device of FIG. 3;

FIG. 5 is a lateral view in perspective of a distribution device according to a third embodiment of the invention;

FIG. 6 is a lateral view, in perspective, of a distribution device according to a fourth embodiment of the invention;

FIG. 7 is an enlargement of the element VI of the distribution device of FIG. 6;

FIG. 8 is a cross-sectional view along the section VII-VII of the distribution device of FIG. 6;

FIG. 9 is a cross-sectional view of a distribution device according to a fifth embodiment;

FIG. 10 is a sectional view along YZ of a linear deposition system integrating a distribution device according to the invention;

FIG. 11 is a sectional view along XZ of the linear deposition system of FIG. 10;

FIGS. 12A and 12B illustrate the device of FIG. 1 in cross section, respectively in its equilibrium position, before the start of distribution and in its oscillation limit position, during distribution.

### DETAILED DESCRIPTION

FIG. 1 illustrates a device 10 for the linear distribution of a material M according to a first embodiment of the invention.

The material M is typically a powder, in particular a sticky or pulverized powder, more particularly a powder whose grains have an average diameter of between 50 microns and 1 millimeter.

In the example shown in FIG. 1, the device comprises:
a reservoir 20 mounted for rotation about an axis X defining a longitudinal direction, and
means 30 for driving the reservoir 20 in an oscillating movement about its axis X.

In the position of use of device 10, the X axis is positioned horizontally.

The reservoir 20 delimits a storage cavity 42 of length L3.

It comprises, in the example, a reservoir body 40 in the form of a straight cylinder with a circular cross section, comprising two axial end walls 40a, 40b parallel to each other and connected by a main wall 41.

The storage cavity 42, delimited inside said body 40, has a cylindrical inner surface of circular cross section, which limits the adhesion of the material to said surface.

The storage cavity 42 is intended to contain a permanent supply of material M, as will be described in greater detail below.

As illustrated in FIG. 1, the reservoir 20 has a first opening 50, typically circular or oblong in shape, for the entry of material into the cavity 42 and a second opening 60 in the form of a longitudinal slot, for the exit of material from the cavity 42 and extending over substantially its entire length L3.

In the example shown, the first opening 50 is centered longitudinally between the two end walls 40a and 40b.

In operation of the device 10, and in particular in its equilibrium position, the first opening 50 is oriented generally upwards, with respect to the vertical direction, and the second opening 60 generally downwards. In other words, the second opening 60 is located below a horizontal plane XY including the X axis, and the first opening 50 is generally located above said horizontal plane XY.

Advantageously, the first and second openings 50, 60 are opposite each other in a radial direction orthogonal to the longitudinal direction X (i.e., at least one radial direction intersects each of the two openings 50, 60).

In the particular example shown, the two openings 50, 60 are each symmetrical with respect to a radial plane XZ, in the equilibrium state of the device 10.

As illustrated, the length L2 of the second opening 60, measured in the longitudinal direction X, is greater than the length L1 of the first opening 50 measured in the same direction X. More specifically, the ratio between the length L1 of the first opening 50 (its maximum dimension measured in the longitudinal direction) and the length L2 of the second opening 60 is typically between 0.1 and 0.5. In the example shown in FIG. 1, it is, for example, equal to 0.3.

The length L2 of the second opening 60 determines the length of a material distribution zone, and must therefore be chosen or adjusted as required. It is typically between 500 and 2000 mm.

The length of the first opening can be between 50 and 500 mm, for example.

The second opening 60 preferably has a constant width w2 along its entire length L2.

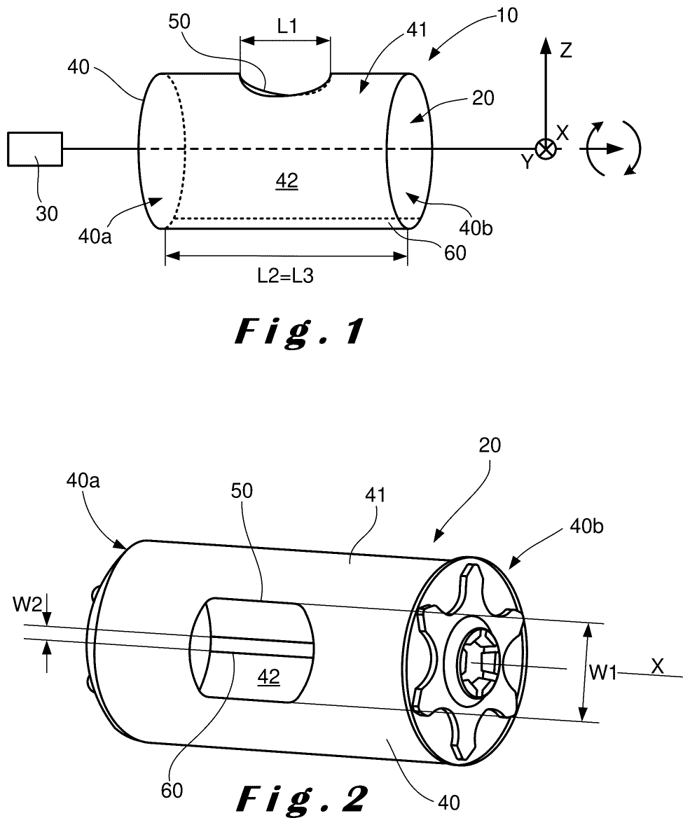

As illustrated in FIG. 2, this width w2 is typically smaller than the width w1 of the first opening 50. This is not, however, limiting.

The width w2 of the second opening 60 is in fact selected so that the material M is not discharged directly from the storage cavity 42, but is instead held there temporarily before distribution.

Thus, the width w2 of the second opening 60 depends on the nature of the material M to be distributed, and in particular on its particle size.

It is preferably greater than at least 3 times the average particle diameter of the material M, and more preferably greater than 5 times this average diameter.

The means 30 for driving the reservoir, shown schematically in FIG. 1, may be by a motor, or may be non-motorized and include a manual system such as a connecting rod and crank.

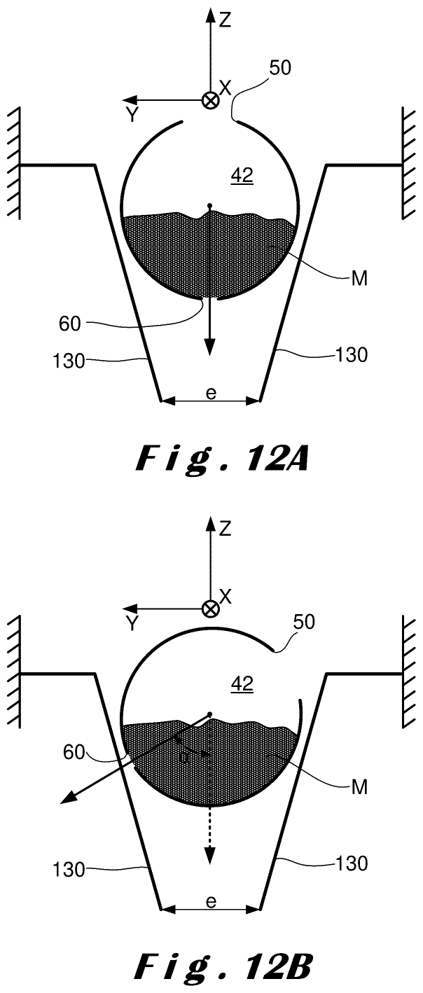

The operation of device 10 is best understood in the light of FIGS. 12A and 12B.

Material M is introduced into the storage cavity 42 through the first opening 50.

Before material distribution begins, a reserve of this material is first formed inside the storage cavity 42, as illustrated in FIG. 12A.

As the second opening 60 is in the form of a narrow slot, the material M is not discharged directly from the storage cavity 42. The width w2 of the second opening 60 is chosen with this in mind, also depending on the nature and, in particular, the particle size and flowability of the material, which may vary.

During the distribution, the reservoir 20 is set in motion around its axis of rotation X, by the action of the drive means 30.

More specifically, the reservoir 20 is subjected to an oscillating movement whose frequency is at least 0.5 Hz and may be between 1 and 20 Hz, preferably between 1 and 10 Hz. The angle α of oscillation of reservoir 20 (see FIG. 12B) about axis X is typically greater than 5 degrees, preferably between 5 and 45 degrees, even more preferably between 10 and 30 degrees.

Maintaining a permanent supply of material inside the reservoir and the oscillating movement of the reservoir enable the material to be distributed with a homogeneous grain size inside the storage cavity 42 and in particular over the entire length L2 of the second opening 60.

As shown in FIGS. 12A, 12B, it is advantageous, to further improve distribution homogeneity, that the volume of material oscillates little or not at all with the reservoir 20. A relative oscillation is thus obtained between the material M contained inside the storage cavity 42 and the inner surface of said cavity 42.

The reservoir 20, and in particular the inner surface of the reservoir body 40, may for example be made of a metallic material, notably stainless steel. The reservoir body 40 may also be internally coated to limit adhesion of material M. The reservoir body 40 and/or a coating covering the inside of the body 40 can also be made of a non-metallic material, typically a polymeric material, in particular PTFE, to prevent the material from being contaminated by wear particles.

As shown in FIGS. 12A, 12B, the device 10 comprises two deflectors 130 arranged outside the reservoir 20 and on either side of the second opening 60, so as to be able to guide the material as it is dispensed. In the example, the deflectors 130 are attached to a fixed frame 160 of the device. The distance e between the two deflectors, defining the width of the material distribution zone, is typically between 5 and 100 mm.

According to a particular arrangement of the invention, one or each deflector can be movable and adjustable in position, so as to be able to vary the spacing e and thus the width of the distribution zone.

As explained above, the width of the second opening ensures that a reserve of material M remains inside the storage cavity 42. However, this width varies according to the properties of the material, in particular its particle size and flowability. In order to be able to adapt the device to different materials, it is therefore advantageous for the width w2 of the second opening 60 to be adjustable.

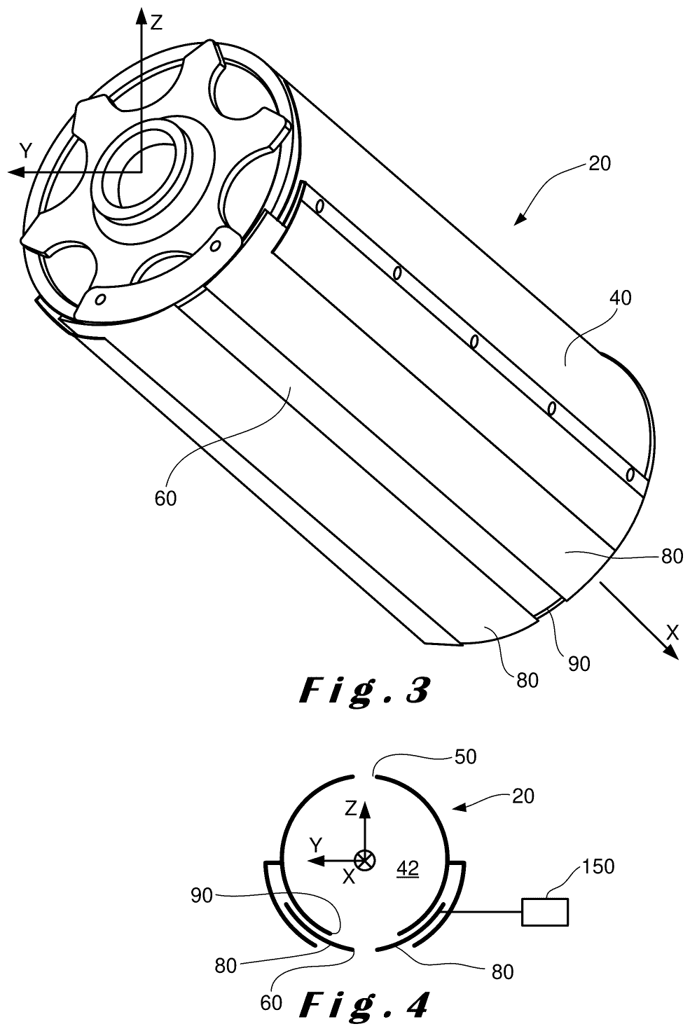

FIGS. 3 and 4 illustrate a device for linear distribution of a material in which the reservoir 20 is provided with means for adjusting 70 the width w2 of its second opening 60.

In the example shown in FIGS. 3 and 4, the reservoir body 40 comprises a window 90 and two adjustable elements 80 movably mounted on either side of this window 90 and partially obturating it, the portion of the window 90 not obturated forming the second opening 60 of the reservoir 20. Alternatively, the reservoir could comprise a single adjustable element 80.

The width of the second opening 60 can be adjusted manually by the user, using any suitable locking system. Alternatively, the adjustment can be motorized, and in particular actuated by a control unit 150 configured to operate either under the effect of a user instruction in this direction, or as part of a feedback loop operating intermittently or continuously and typically based on measurement results of at least one parameter representative of the volume of material M inside cavity 42.

According to a variant not shown, the device 10 could also include means for adjusting the length L2 of the second opening 60, enabling the distribution length to be adapted according to need and thus varying the device's possibilities of use.

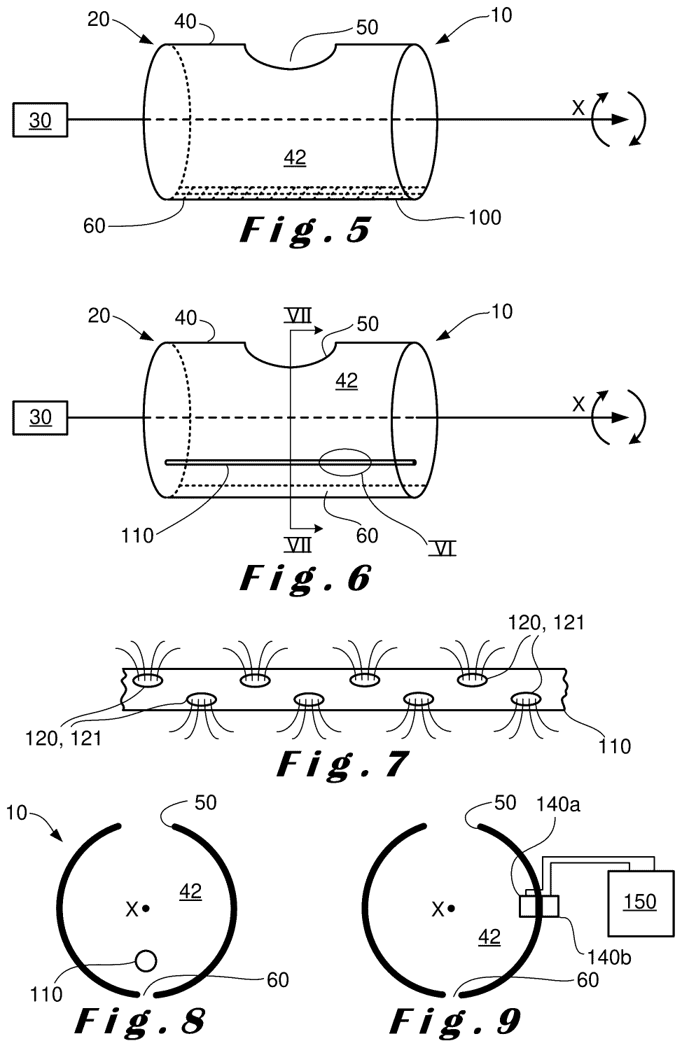

FIG. 5 illustrates a device 10 according to a third embodiment of the invention, in which the tank 20 comprises a sieve 100 completely covering the second opening 60. The sieve 100 is formed of orifices of a diameter that allows the material to pass through according to its particle size, but prevents the passage of agglomerates.

Depending on the nature of the material, the diameter of the orifices may, for example, be between 1 and 15 mm, said diameter corresponding to the diameter of a circle inscribed inside said orifice.

FIG. 6 illustrates a device 10 according to a fourth embodiment of the invention.

The device 10 here comprises a flow-disturbing element 110 accommodated inside the storage cavity 42 of the reservoir 20.

In the illustrated example, the flow-disturbing element 110 is in the form of a bar fixed inside the reservoir body 40 and extending parallel to the longitudinal axis X, over the entire length of the storage cavity 42 or at least over the entire length L2 of the second opening 60.

As illustrated in FIG. 8, which shows the same device 10 in cross-section, bar 110 is advantageously positioned radially in line with and close to the second opening 60, typically at a distance, measured radially, substantially similar to the width of the second opening.

In addition or alternatively, one or more flow-disrupting elements 110 having other shapes can be arranged inside the storage cavity 42 to break up the material agglomerates there. For example, one or more blades or helices can be attached to the body 40 and/or balls can be arranged inside the storage cavity 42 without being attached to the reservoir.

According to a particularly advantageous arrangement illustrated in FIG. 7, the device 10 may further comprise at least one fluidizing element 120 promoting material migration towards the axial ends of the storage cavity 42. For example, the device may comprise air nozzles 121 integrated into the flow-disrupting element 110 in the form of a bar. Alternatively, other fluidizing elements 120 may be used, such as a vibrating system.

Thanks to the fluidizing elements 120, the material can be distributed at the outlet with a homogeneous volumetry and particle size over the entire length L2.

As illustrated in FIG. 9, it is advantageous for the device to include at least one sensor 140a, 140b for measuring parameters representative of the amount of material inside the storage cavity 42. The sensor(s) 140a, 140b may, for example, be placed in the storage cavity 42 and/or outside the reservoir 20 and/or on the shaft of the reservoir 20, depending on the parameter(s) they are intended to measure.

A sensor 140a, 140b may, for example, measure the mass of the reservoir 20, or a height of material M, particularly at one or both longitudinal ends of the cavity, or a variation in the angle or speed of oscillation.

The measured values are then transmitted to the control unit 150, which compares each measured value with a target value or range of values. In this way, the system adapts throughout the entire service life of the linear material distribution device 10 to ensure continuous, homogeneous volumetric and particle size distribution of the material M.

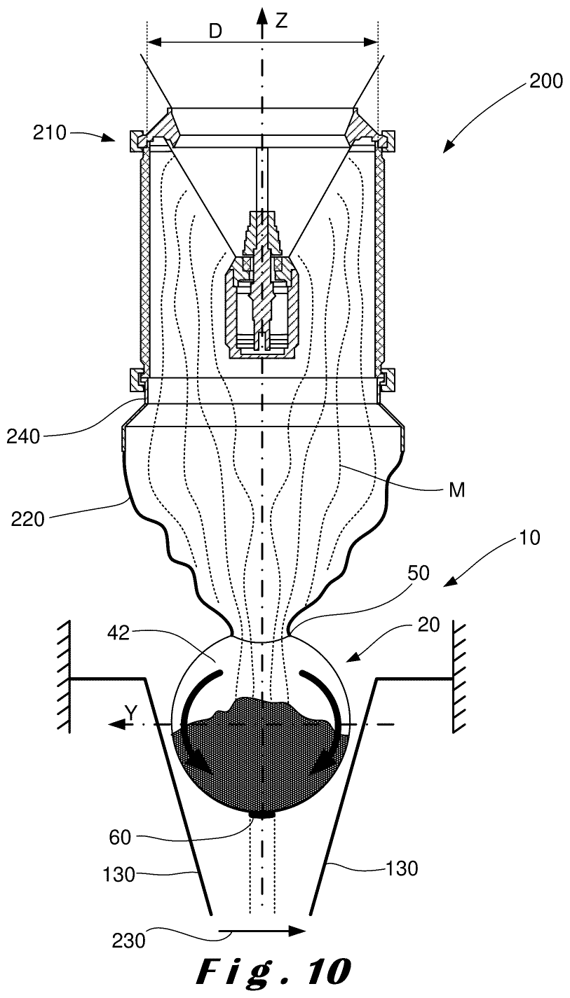

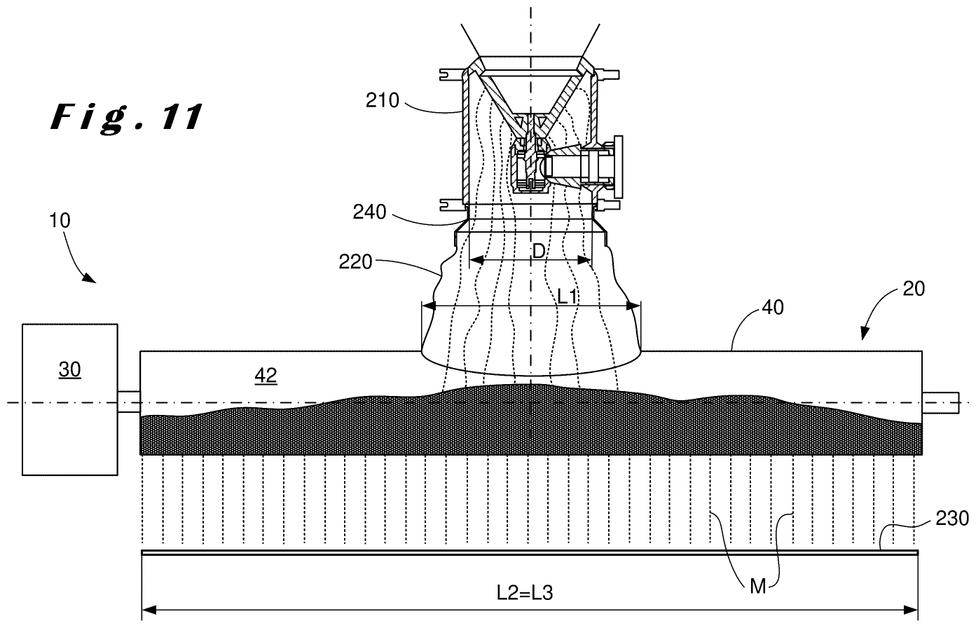

FIGS. 10 and 11 illustrate a system of linear deposition 200 of a material M according to the invention.

The linear deposition system 200 comprises:
a material feed device 210 provided with an outlet 240,
a linear distribution device 10 as defined above,
a deformable connecting element 220 which connects the outlet orifice 240 of the material feed device 210 and the first opening 50 of the linear distribution device 10 in a sealed manner,
a receiving device 230 arranged to receive the material dispensed by the linear distribution device 10 through the second opening 60.

In the particular example illustrated, the feed device 210 for material M, the connecting element 220, the distribution device 10 and the receiving device 230 are all vertically aligned along the Z axis.

The material feed device 210 is, for example, a mill which delivers the material in powder form through its outlet orifice 240, typically circular in shape and of diameter D, typically between 50 and 500 mm.

However, other material feed devices 210 and other outlet orifice shapes 240 (e.g. oval, rectangular or square) can also be envisaged.

Thanks to the linear distribution device according to the invention, the ratio between the diameter D and the length L2 of the second opening 60 can be between 0.1 and 0.5, as will be described below.

In one example, connecting element 220 can be made of a flexible material. Natural, synthetic or flexible metal materials can be used as flexible material.

The receiving device 230 can be fixed and/or movable, generally movable and designed to continuously convey the distributed material. It is typically a conveyor belt or a rolling mill.

According to an implementation mode of the method for using the device 10 of the present invention, a quantity of material is first introduced into the storage cavity 42 through the first opening 50, so as to create a reserve of this material M in said cavity.

The minimum height of this reserve, measured radially in line with an axial end of the second opening, is preferably greater than 25% of the reservoir diameter measured in this same direction.

The volume of the reserve is preferably at least 50% of the total internal volume of the storage cavity.

During this preliminary filling stage, the reservoir 20 is typically held in its equilibrium position (FIG. 12A) or, conversely, in a pivoted position (which may correspond to its oscillation limit, FIG. 12B) to prevent material from escaping.

Then, during dispensing, the reservoir 20 is subjected to an oscillating movement about its axis X to distribute the material through the second opening 60.

The amount of material introduced, the width w2 of the second opening 60 and the oscillation characteristics of the reservoir 20 are chosen so that, during dispensing, the reserve of material is kept permanently inside the storage cavity 42.

Advantageously, the material M is introduced through the first opening 50 at a constant flow rate, e.g. between 50 and 500 kg/h, and the outlet flow rate of the material M through the second opening 60 is generally substantially equal to this inlet flow rate.

By “substantially equal”, we mean that the variation in flow rate preferably does not exceed a few %, typically 5%, which will be compensated for by the reserve or by a control system implementing sensors as defined above in connection with FIG. 9.

According to an example of implementation, at least one parameter representative of the quantity of material inside the storage cavity can be measured during distribution. This parameter may, for example, be the mass of the material contained in the cavity, a height of the material inside the cavity, a variation in the angle or speed of oscillation, etc.

Then at least one parameter from among the material inlet flow rate through the first opening, the reservoir oscillation angle, the reservoir oscillation frequency and the width of the second opening can be adjusted, if required, so that the parameter(s) remain(s) within a predetermined value range.

Control is preferably performed in a closed loop, either intermittently or continuously.

Under the effect of the oscillating movement of the reservoir, the reserve is continuously distributed inside cavity 42 so as to extend to both ends of cavity 42, as illustrated in FIG. 11, and the material is distributed at the outlet with homogeneous volumetry and particle size over the entire length L2.

1. A device for linear distribution of a material, said device comprising:
a reservoir mounted for movement about an axis defining a longitudinal direction, the reservoir delimiting a storage cavity and being provided with a first opening for the entry of material into said cavity and a second opening in the form of a longitudinal slot for the exit of material from said cavity; and
means for driving the reservoir in an oscillating movement about said axis.

2. The linear distribution device according to claim 1, wherein a ratio between a length of the first opening and a length of the second opening is between 0.1 and 0.5.

3. The linear distribution device according to claim 1, further comprising means for adjusting a width of the second opening.

4. The linear distribution device according to claim 1, further comprising a sieve at least partially covering the second opening.

5. The linear distribution device according to claim 1, comprising at least one flow-disrupting element accommodated inside the storage cavity.

6. The linear distribution device according to claim 1, further comprising at least one element for fluidizing the material inside the storage cavity.

7. The linear distribution device according to claim 1, wherein a width of the second opening is greater than 3 times an average particle diameter of the material.

8. The linear distribution device according to claim 1, further comprising deflectors arranged outside the reservoir and configured to guide the material out of the second opening.

9. The linear distribution device, according to claim 1, further comprising at least one sensor configured to measure at least one parameter representative of an amount of material inside the storage cavity.

10. The linear distribution device according to any claim 1, further comprising means for adjusting a length of the second opening.

11. A linear material deposition system comprising:
a material feed device configured to deliver material through an outlet;
the linear distribution device according to claim 1; and
a receiving device arranged to receive the material distributed by the linear distribution device.

12. The linear deposition system according to claim 11, further comprising a deformable connecting element configured to connect the outlet of the material feed device and the first opening in a sealed manner.

13. A method of using the linear distribution device of claim 1, wherein a quantity of material is introduced into the storage cavity through the first opening and the reservoir is subjected to an oscillating movement about said axis to dispense the material through the second opening.

14. The method according to claim 13, wherein the quantity of material introduced, a width of the second opening and oscillation characteristics of the reservoir are such that, during distribution, a reserve of material is permanently maintained inside the storage cavity.

15. The method according to claim 13, wherein an angle of oscillation of the reservoir about said axis is greater than 5 degrees.

16. The method according to claim 13, wherein a frequency of oscillation of the reservoir about said axis is at least 0.5 Hz.

17. The method according to claim 13, wherein the material is introduced continuously through the first opening.

18. The linear distribution device according to claim 5, said at least one flow-disrupting element being in line with the second opening.

19. The method of claim 15, said angle of oscillation being between 10 and 30 degrees.

20. The method according to claim 16, wherein a frequency of oscillation of the reservoir about said axis is between 1 and 10 Hz.
